(19) United States
(12) Patent Application Publication
(10) Pub. No.: US 2024/0205995 A1
(43) Pub. Date: Jun. 20, 2024

(54) MULTI-LINK DEVICE FRAME EXCHANGE WITHIN A WLAN (WIRELESS LOCAL AREA NETWORK)

(71) Applicant: NXP USA, Inc., Austin, TX (US)

(72) Inventors: Liwen Chu, San Ramon, CA (US); Kiseon Ryu, San Diego, CA (US); Huizhao Wang, San Jose, CA (US); Hongyuan Zhang, Fremont, CA (US)

(21) Appl. No.: 18/535,624

(22) Filed: Dec. 11, 2023

Related U.S. Application Data
(60) Provisional application No. 63/476,160, filed on Dec. 19, 2022.

(51) Int. Cl. H04W 76/15

(52) U.S. Cl. CPC H04W 76/15; H04W 84/12

(57) ABSTRACT

One example discloses a first WLAN (wireless local area network) device, including: a controller configured to, establish a multi-link association with a second WLAN device; wherein the multi-link association includes a primary link and a non-primary link; detect that the primary-link is busy; and perform frame exchanges on the non-primary link if the primary-link is busy.

### REFERENCE TO PROVISIONAL APPLICATION TO CLAIM PRIORITY

A priority date for this present U.S. patent application has been established by prior U.S. Provisional Patent Application, Ser. No. 63/476,160, entitled “MLSR non-AP MLD Operation”, filed on Dec. 19, 2022, and commonly assigned to NXP USA, Inc.

The present specification relates to systems, methods, apparatuses, devices, articles of manufacture and instructions for multi-link device frame exchange within a WLAN (Wireless Local Area Network).

### SUMMARY

According to an example embodiment, a first WLAN (wireless local area network) device, comprising: a controller configured to, establish a multi-link association with a second WLAN device; wherein the multi-link association includes a primary link and a non-primary link; detect that the primary-link is busy; and perform frame exchanges on the non-primary link if the primary-link is busy.

In another example embodiment, the first WLAN device is an AP (access point) MLD (multi-link device); and the first WLAN device is a non-AP MLD.

In another example embodiment, further comprising: detect that the primary-link is no longer busy; and perform frame exchanges on the primary link if the primary-link is no longer busy.

In another example embodiment, the primary link is busy if either the first or second WLAN devices holds a TXOP.

In another example embodiment, the first WLAN device communicates with the second WLAN device simultaneously over both the primary link and the non-primary link.

In another example embodiment, if either the first or second WLAN devices loses communications medium synchronization when switching between the primary link and the non-primary link, and a peer device to either the first or second WLAN devices has the medium synchronization information, then the peer device performs communications medium re-synchronization by transmitting an RTS frame to at least one of the first or second WLAN devices, and detects a received PPDU.

In another example embodiment, the RTS frame use an ED based backoff within a time period defined by a MediumSyncDelay timer, and the peer device detects a timeout of the MediumSyncDelay timer.

In another example embodiment, the second WLAN device is included a set of affiliated WLAN devices; and each of the set of affiliated WLAN devices selects its own primary link.

In another example embodiment, the second WLAN device is included a set of affiliated WLAN devices; and the first WLAN device assigns a primary link to each device in the set of affiliated WLAN devices.

In another example embodiment, each of the set of affiliated WLAN devices shares a common setup link.

In another example embodiment, at least one of the first and second WLAN devices requests enabling of the primary link and the non-primary link mode of operation; and a peer device to the at least one of the first and second WLAN devices decides whether or not to accept or reject the request for the primary link and the non-primary link mode of operation.

In another example embodiment, at least one of the first and second WLAN devices requests disabling of the primary link and the non-primary link mode of operation; and a peer device to the at least one of the first and second WLAN devices stops using the primary link and the non-primary link mode of operation in response to the request disabling.

In another example embodiment, at least one of the first and second WLAN devices announces enablement of the primary link and the non-primary link mode of operation using at least one of: a basic multi-link element, a reduced neighbor report, an additional element in a beacon frame, another management (i.e. action) frame, a trigger frame, or a control frame.

In another example embodiment, the announces includes a link identifier (ID) that identifies which of the WLAN devices is using which link as the primary link, and which link as the non-primary link.

In another example embodiment, the primary link and a non-primary link are in a same power save mode at a same time.

In another example embodiment, the primary link and a non-primary link are in a different power save mode at a same time.

In another example embodiment, the primary link and a non-primary link are in an awake state in a power save mode at a same time.

In another example embodiment, at least one of the first and second WLAN devices is a multi-link single-radio (MLSR) device.

In another example embodiment, at least one of the first and second WLAN devices is a multi-link multi-radio (MLMR) device.

In another example embodiment, at least one of the first and second WLAN devices is a STR (Simultaneous Transmit and Receive) MLMR (Multilink Multi-Radio) MLD device.

According to an example embodiment, a method of enabling a first WLAN (wireless local area network) device to be operated, comprising: establishing a multi-link association with a second WLAN device; wherein the multi-link association includes a primary link and a non-primary link; detecting that the primary-link is busy; and performing frame exchanges on the non-primary link if the primary-link is busy.

The above discussion is not intended to represent every example embodiment or every implementation within the scope of the current or future Claim sets. The Figures and Detailed Description that follow also exemplify various example embodiments.

Various example embodiments may be more completely understood in consideration of the following Detailed Description in connection with the accompanying Drawings.

### BRIEF DESCRIPTION OF THE DRAWINGS

FIG. 1 represents a general example multi-link communications system.

FIG. 2 represents an example setup between a set of multi-link devices (MLDs) using primary links and non-primary links.

FIG. 3 represents an example setup between the set of multi-link devices (MLDs) using primary links and non-primary links while in a power save mode.

FIG. 4 represents an example system including an example set of instructions for setting up a primary link and a non-primary link between a set of multi-link devices (MLDs).

While the disclosure is amenable to various modifications and alternative forms, specifics thereof have been shown by way of example in the drawings and will be described in detail. It should be understood, however, that other embodiments, beyond the particular embodiments described, are possible as well. All modifications, equivalents, and alternative embodiments falling within the spirit and scope of the appended claims are covered as well.

### DETAILED DESCRIPTION

Wireless communications systems are useful in a variety of applications, including industrial, medical, computer network, edge, and home applications. These wireless communications systems, such as specified by the IEEE § 802.11.be protocol can include single-link or multi-link communications between various access points (APs) and-stations (STAs).

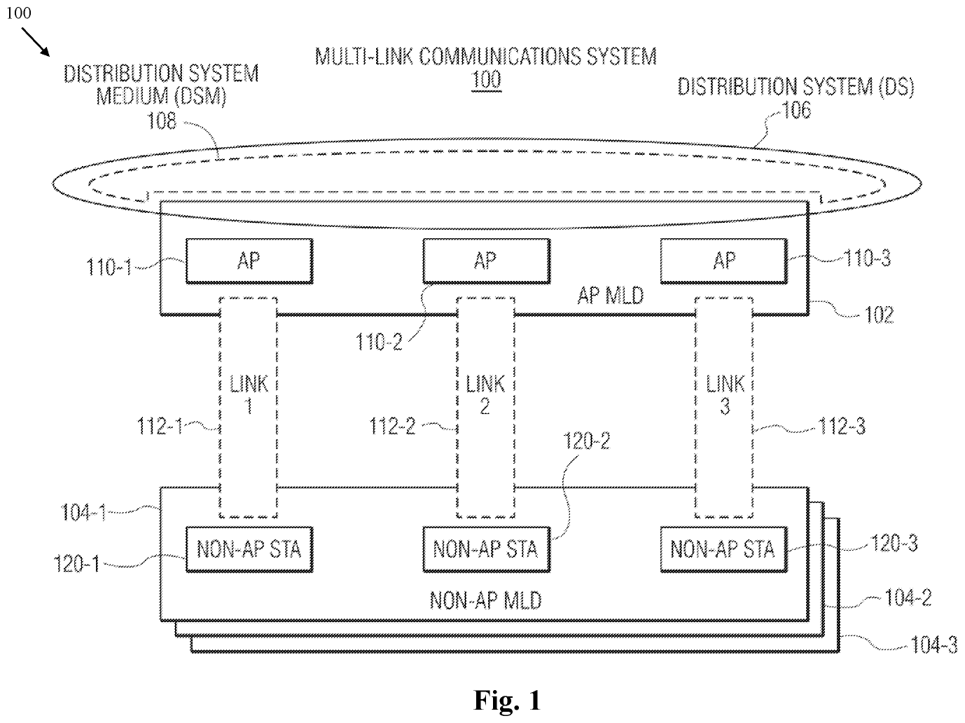

FIG. 1 represents a general example multi-link communications system 100. The multi-link communications system 100 includes: at least one logical AP-MLD (Access Point Multi-Link Device) 102; a set of logical non-AP-MLDs 104-1, 104-2, 104-3; a distribution system (DS) 106; and a set of communications links 112-1, 112-2, 112-3. “Logical” is herein defined to include, for example, a set of physical devices abstractly aggregated into a single logical device for the purposes of communication and/or other functions.

For example, the logical AP-MLD 102 can include a set of physical APs (access points) 110-1, 110-2, 110-3. Similarly, the logical non-AP-MLDs 104-1 can include a set of physical non-AP-STA (stations) 120-1, 120-2, 120-3. The other non-AP-MLD 104-2, 104-3 may also include additional physical non-AP-STAs.

The AP-MLD 102 is coupled to a distribution system (DS) 106 through a distribution system medium (DSM) 108. The distribution system (DS) 106 is used to interconnect basic service sets (BSSs) and local area networks (LANs) to create an extended service set (ESS).

In IEEE 802.11 a service set (aka. extended service set (ESS)) is a group of wireless devices which are identified by a same SSID (service set identifier). A service set forms a logical network. A basic service set (BSS) is a subgroup of wireless devices within a service set operating with similar physical layer medium access characteristics (i.e. radio frequency, modulation scheme, security settings etc.) and that are wirelessly networked. Devices within basic service sets are identified by BSSIDs (basic service set identifiers).

The distribution system (DS) 106 may be a wired network or a wireless network that is connected to a backbone network such as the Internet. The DSM 108 may be a wired medium (e.g., Ethernet cables, telephone network cables, or fiber optic cables) or a wireless medium (e.g., infrared, broadcast radio, cellular radio, or microwaves).

The APs 110-1, 110-2, 110-3 may be implemented in hardware (e.g. circuits, IC, etc.), software, firmware, or a combination thereof. The APs 110-1, 110-2, 110-3 may include one or more antennas, transceivers, and controllers operably interconnected. The transceivers may include a physical layer (PHY) device.

The controllers may be configured to process various data packets (e.g. PDUs, SDUs, etc.) received and/or to be transmitted. The APs 110-1, 110-2, 110-3 can be configured as either wired or wireless APs coupled to a LAN (local area network), a WLAN (wireless LAN) network, and/or a backbone network (e.g., the Internet). The AP-MLD 102 may also include a Media Access Control (MAC) data service interface, with associated MAC address that enables this device to communicate with the DSM 108.

Similarly, the non-AP-STAs 120-1, 120-2, 120-3 in the non-AP-MLDs 104-1 may be implemented in hardware (e.g. circuits, IC, etc.), software, firmware, or a combination thereof. The non-AP-STAs 120-1, 120-2, 120-3 may include one or more antennas, transceivers, and controllers operably interconnected. These transceivers may include a physical layer (PHY) device.

The controllers may be configured to process various data packets (e.g. PDUs, SDUs, etc.) received and/or to be transmitted. Each of the non-AP-MLDs 104-2, 104-3 may also include non-AP-STAs (not shown).

The non-AP-MLDs 104-1, 104-2, 104-3 may also include a Media Access Control (MAC) data service interface, with associated MAC addresses that enable these devices to communicate with the DSM 108 over the communications links 112-1, 112-2, 112-3.

Example applications of the non-AP-STAs 120-1, 120-2, 120-3 include: laptop computers, tablet computers, desktop computers, mobile phones, edge devices, or other wireless devices.

In various example embodiments, one or more of the physical APs 110-1, 110-2, 110-3 and/or physical non-AP-STAs 120-1, 120-2, 120-3 may communicate over the links 112-1, 112-2, 112-3 in different frequency bands (e.g. 2.4 GHz, 5 GHz, 6 GHZ, etc.), for example, during multi-link device (MLD) operation setup and data packet (e.g. PDUs, SDUs, etc.) transfers.

In various example embodiments, the physical APs 110-1, 110-2, 110-3 may be either single-radio or multi-radio AP devices, and/or the physical non-AP-STAs 120-1, 120-2, 120-3 may be either single-radio or multi-radio non-AP STA devices.

The physical communications links 112-1, 112-2, 112-3 may be logically defined as including one or more communications channels. In some example embodiments, different links however can be in a same frequency band. For example, two channels on a same 5 GHz band can form multi-links. Thus the links 112-1/2/3 in different channels of the same band are also allowed.

For the discussion that follows, “association” is defined in IEEE 802.11 as a service used to establish a mapping between an access point (AP) or personal basic service set (PBSS) control point (PCP), and a station (STA) and enable STA invocation of the distribution system services (DSSs). 802.11 defines association only as between an AP-device (either single-link AP-device or multi-link AP-device (MLD)) and a non-AP device.

Association also defines basic service set (BSS) identifiers (BSSIDs) (e.g. security, bit rate, etc.) for setting up a data communications link between a-STA/client and an AP. “Reassociation” is defined as when a-STA/client roams away from a first AP and needs to setup a new communications link with a second AP. Here the BSSIDs sent in the reassociation request to the second AP also include a MAC address of the first AP.

Multi-link device setup (i.e. association) between the non-AP-MLD 104-1 and the AP-MLD 102 in accordance with IEEE 802.11be employs a signaling exchange process including; a capability for one or more of the communications links 112-1, 112-2, 112-3; and that the AP-MLD 102 will serve as an interface to the distribution system (DS) 106 for the non-AP-MLD 104-1. This process essentially treats the multi-link setup process for the non-AP-MLD 104-1 as similar to an association process for a single-link non-AP-STA.

Multi-link teardown for a non-AP-MLD 104-1 in accordance with IEEE 802.11be includes a signaling exchange that is similar to a disassociation process for a single-link non-AP-STA 120-1.

Before the standardization of IEEE 802.11be there was no multi-link reassociation between the non-AP-MLD 104-1 and the AP-MLD 102. Instead, before IEEE 802.11be discusses a reassociation only for a physical single-link-STA (e.g. non-AP-STA 120-1) for moving a current association of the single-link-STA from a first AP to a second AP. In an Extended Service Set (ESS) with distribution system (DS) 106, the reassociation service informs the DS 106 of the current communications link mapping between the AP and the non-AP-STA as the non-AP-STA moves from one Basic Service Set (BSS) to another BSS within the ESS.

Multi-Link Operation (MLO) between an AP MLD and a set of non-AP MLDs requires protocols for communications medium synchronization so as to avoid communications collisions between various affiliated non-AP MLDs as they communicate with the AP MLD.

These MLDs may in various examples be MLSR (Multilink Single-Radio) MLDs, EMLSR (Enhanced Multilink Single-Radio) MLDs, and/or MLMR (Multilink Multi-Radio) MLDs.

Existing protocols for avoiding communications medium synchronization problems include use of: STR (Simultaneous Transmit and Receive) modes, where a first subset of the MLD links can receive while a second subset of the links can transmit at a same time; and NSTR (Non-simultaneous Transmit and Receive) modes, where MLD links can only all receive or all transmit at a same time.

However even using these protocols, medium synchronization problems between affiliated non-AP STAs can still be a problem.

Now discussed are example MLD link setups that avoiding communications medium synchronization collisions and other problems by defining a primary link and a non-primary link for each affiliated non-AP STA in communication with an AP MLD.

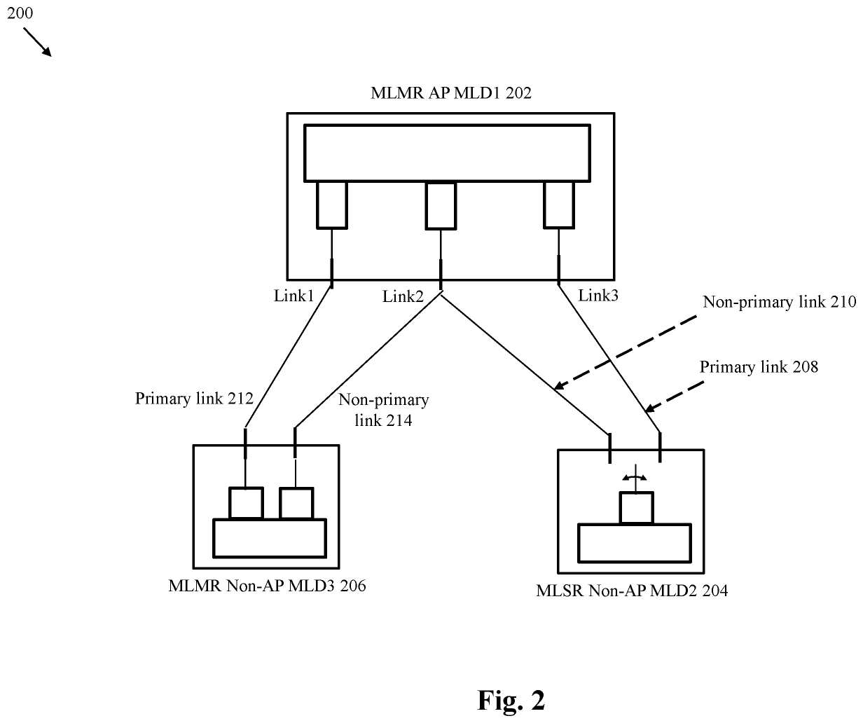

FIG. 2 represents an example setup 200 between a set of multi-link devices (MLDs) using primary links and non-primary links. The set of MLDs includes an AP MLD1 202 with a set of affiliated APs; an MLSR non-AP MLD2 204, which is affiliated with a set of non-AP STAs (not shown); and an MLMR non-AP MLD3 206, which is affiliated with a set of non-AP STAs (not shown).

In one embodiment, MLD2 204 has one primary link 208 and one or more non-primary link(s) 210 which are announced by the AP MLD. All the MLSR non-AP MLDs that have link 208 and link 210 as their setup links, have link 208 as their primary link. In another embodiment, each of MLD2 204 announces its own primary links and non-primary links.

When the primary link 208 of MLD2 204 is busy (e.g. holds a TXOP for a first set of frame exchanges) because of an OBSS's TXOP, MLD2 204 will use the non-primary link 210 for a second set of frame exchanges by switching its radio to the non-primary link. At an end of the TXOP on the primary link 208, MLD2 204 switches back to using the primary link 208 for a third set of frame exchanges.

If MLD2 204 loses communications medium synchronization when switching between the primary link 208 and the non-primary link 210, and MLD2's 204 peer in AP MLD1 202 has the medium synchronization information, then in some example embodiments MLD2 204 can do the backoff by using ED level (e.g. −72 dbm) to detect the medium busy/idle within a time period and transmit an RTS frame to the AP MLD1 202 to solicit CTS after the backoff counter becomes 0.

In other example embodiments MLD2 204 can perform communications medium re-synchronization by transmitting an RTS frame using an ED based backoff within a time period defined by a MediumSyncDelay timer, and detecting a timeout of the MediumSyncDelay timer.

In some example embodiments, in a set of links with associated MLSR non-AP MLDs, an AP MLD indicates one link as the primary link. The other links in the set will be non-primary links. In some example embodiments, the set of links include two links.

All the affiliated APs of an AP MLD will transmit their Beacons.

Then when the primary link is busy because of OBSS's TXOP, the AP MLD uses the non-primary links (i.e. the physical links not used for Beacon transmission) for frame exchanges between the AP-MLD and the non-AP MLDs until an end of OBSS's TXOP in the primary link. With this approach, medium synchronization operations between the primary when switching back to primary link can be avoided.

### Identifying the Primary Link:

In some example embodiments, each of MLD2 204 with setup link 2 and link 3 selects its own primary link (e.g. one MLD2 204 selects link 3 as its primary link 208 and another MLD2 204 selects link2 as its primary link).

Note, the setup link is used by the AP MLD to set up (e.g. negotiate) communications between the AP MLD and the non-AP MLDs, such as MLD2 204.

In other example embodiments, the AP MLD assigns a primary link to as all associated MLD2 204 with the same group of setup links.

Enabling primary link and non-primary link mode of operation:

Either the AP MLD1 202 or the non-AP MLDs (i.e. MLD2 204, and MLD3 206) or their affiliates can request enabling (e.g. activation) of the primary link and non-primary link mode of operation.

Peer MLDs (i.e. either the AP-MLD 202 or affiliated non-AP MLD devices) can individually decide whether or not to accept or reject the request for primary link and non-primary link mode of operation.

Similarly, either the AP MLD1 202 or the non-AP MLDs (i.e. MLD2 204, and MLD3 206) or their affiliates can request disabling (e.g. deactivation) of the primary link and non-primary link mode of operation.

Upon such a request, a MLD device using the primary link and non-primary link mode of operation will stop using the primary link and non-primary link mode of operation.

Primary link and non-primary link negotiation and announcement:

Upon a request by any of the MLD devices to use the primary link and non-primary link mode of operation, the AP MLD 202 can announce enablement of the primary link and non-primary link mode of operation using at least one of: a basic multi-link element, a reduced neighbor report, an additional element in a beacon frame, another management (i.e. action) frame, etc.

In some example embodiments, the AP MLD's 202 announcement includes a link identifier (ID) that identifies which non-AP MLD is using which link as a primary link, and which link(s) as non-primary links.

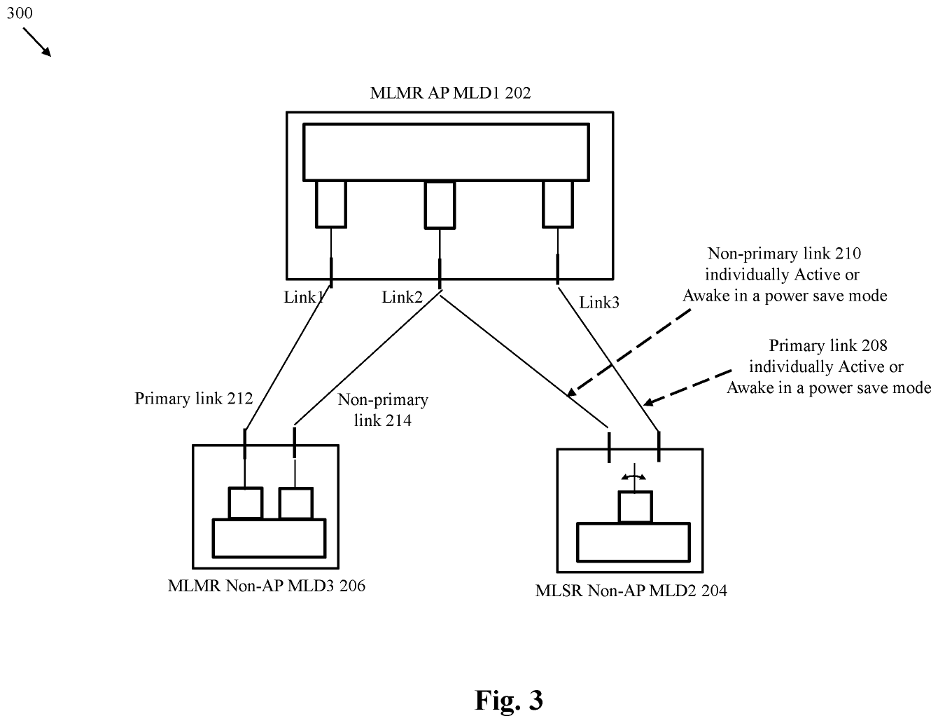

FIG. 3 represents an example setup 300 between the set of multi-link devices (MLDs) using primary links and non-primary links while in active mode. In the example setup 300 at least STAs affiliated with MLD2 204 are either in active mode or switching into or out of the awake state in power save mode in a link when switching to the link.

When MLD2 204 has setup links (e.g. link2 and link3) with an STR AP MLD (e.g. MLD1 202) and has identified the primary link 208 and the non-primary link 210, then the primary link 208 and the non-primary link 210 can be individually either in an active mode, or in an awake state if in the power save mode.

Changes in the MLD2's 204 power management mode and/or awake or doze state can be indicated through either cross-link signaling, or per link signaling.

When both the primary link 208 and the non-primary link 210 of the MLD2 204 are in their active mode and the primary link 208 is busy, then the AP MLD (MLD1 202) can use the non-primary link 210 for frame exchanges with MLD2 204.

When MLD2 204 is in an awake state under power save mode in both links 208 and 210, and the primary link 208 is busy, then the AP MLD (MLD1 202) can use the non-primary link 210 for frame exchanges with the MLD2 204.

In contrast, IEEE 802.11be baseline, permits only one link of an MLSR non-AP MLD to be in an active mode, or an awake state of power save mode.

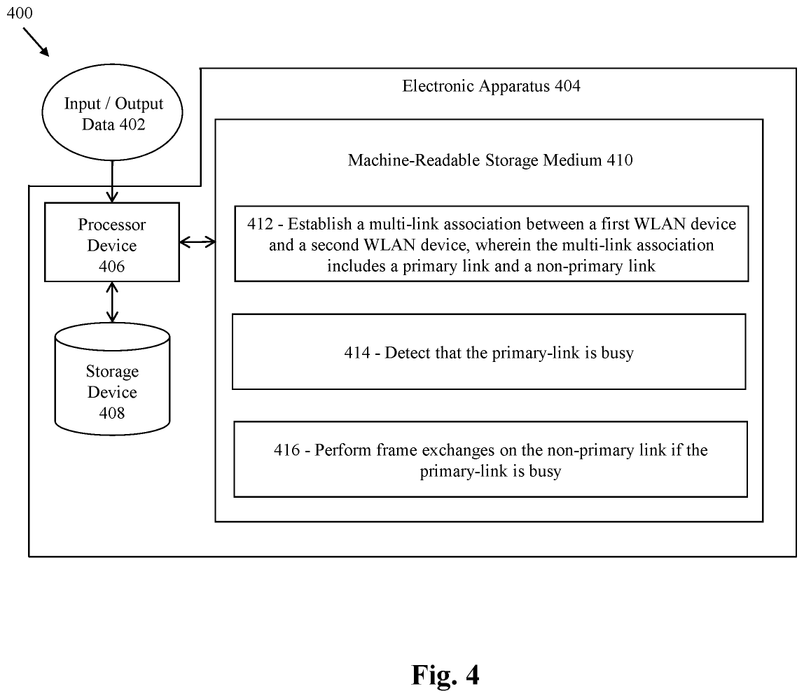

FIG. 4 represents an example system 400 including an example set of instructions for setting up a primary link and a non-primary link between a set of multi-link devices (MLDs). The order in which the instructions are discussed does not limit the order in which other example embodiments implement the instructions unless otherwise specifically stated. Additionally, in some embodiments the instructions are implemented concurrently.

The system 400 shows an input/output data 402 interface with a computing device 404. The computing device 404 includes a processor device 406, a storage device 408, and a machine-readable storage medium 410. Instructions within the machine-readable storage medium 410 control how the processor 406 interprets and transforms the input data 402, using data within the storage device 408. The machine-readable storage medium in an alternate example embodiment is a computer-readable storage medium.

In one example, the instructions stored in the machine-readable storage medium 410 include: 412—Establish a multi-link association between a first WLAN device and a second WLAN device, wherein the multi-link association includes a primary link and a non-primary link; 414—detect that the primary-link is busy; and 416—perform frame exchanges on the non-primary link if the primary-link is busy.

Various instructions and/or operational steps discussed in the above Figures can be executed in any order, unless a specific order is explicitly stated. Also, those skilled in the art will recognize that while some example sets of instructions/steps have been discussed, the material in this specification can be combined in a variety of ways to yield other examples as well, and are to be understood within a context provided by this detailed description.

In some example embodiments these instructions/steps are implemented as functional and software instructions. In other embodiments, the instructions can be implemented either using logic gates, application specific chips, firmware, as well as other hardware forms.

When the instructions are embodied as a set of executable instructions in a non-transitory computer-readable or computer-usable media which are effected on a computer or machine programmed with and controlled by said executable instructions. Said instructions are loaded for execution on a processor (such as one or more CPUs). Said processor includes microprocessors, microcontrollers, processor modules or subsystems (including one or more microprocessors or microcontrollers), or other control or computing devices. A processor can refer to a single component or to plural components. Said computer-readable or computer-usable storage medium or media is (are) considered to be part of an article (or article of manufacture). An article or article of manufacture can refer to any manufactured single component or multiple components. The non-transitory machine or computer-usable media or mediums as defined herein excludes signals, but such media or mediums may be capable of receiving and processing information from signals and/or other transitory mediums.

It will be readily understood that the components of the embodiments as generally described herein and illustrated in the appended figures could be arranged and designed in a wide variety of different configurations. Thus, the detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

What is claimed is:

1. A first WLAN (wireless local area network) device, comprising:
a controller configured to,
establish a multi-link association with a second WLAN device;
wherein the multi-link association includes a primary link and a non-primary link;
detect that the primary-link is busy; and
perform frame exchanges on the non-primary link if the primary-link is busy.

2. The first WLAN device of claim 1:
wherein the first WLAN device is an AP (access point) MLD (multi-link device); and
wherein the first WLAN device is a non-AP MLD.

3. The first WLAN device of claim 1, further comprising:
detect that the primary-link is no longer busy; and
perform frame exchanges on the primary link if the primary-link is no longer busy.

4. The first WLAN device of claim 3:
wherein the primary link is busy if either the first or second WLAN devices holds a TXOP.

5. The first WLAN device of claim 1:
wherein the first WLAN device communicates with the second WLAN device simultaneously over both the primary link and the non-primary link.

6. The first WLAN device of claim 1:
wherein if either the first or second WLAN devices loses communications medium synchronization when switching between the primary link and the non-primary link, and a peer device to either the first or second WLAN devices has the medium synchronization information, then the peer device performs communications medium re-synchronization by transmitting an RTS frame to at least one of the first or second WLAN devices, and detects a received PPDU.

7. The first WLAN device of claim 6:
wherein the RTS frame use an ED based backoff within a time period defined by a MediumSyncDelay timer, and the peer device detects a timeout of the MediumSyncDelay timer.

8. The first WLAN device of claim 1:
wherein the second WLAN device is included a set of affiliated WLAN devices; and
wherein each of the set of affiliated WLAN devices selects its own primary link.

9. The first WLAN device of claim 1:
wherein the second WLAN device is included a set of affiliated WLAN devices; and
wherein the first WLAN device assigns a primary link to each device in the set of affiliated WLAN devices.

10. The first WLAN device of claim 8:
wherein each of the set of affiliated WLAN devices shares a common setup link.

11. The first WLAN device of claim 1:
wherein at least one of the first and second WLAN devices requests enabling of the primary link and the non-primary link mode of operation; and
wherein a peer device to the at least one of the first and second WLAN devices decides whether or not to accept or reject the request for the primary link and the non-primary link mode of operation.

12. The first WLAN device of claim 1:
wherein at least one of the first and second WLAN devices requests disabling of the primary link and the non-primary link mode of operation; and
wherein a peer device to the at least one of the first and second WLAN devices stops using the primary link and the non-primary link mode of operation in response to the request disabling.

13. The first WLAN device of claim 1:
wherein at least one of the first and second WLAN devices announces enablement of the primary link and the non-primary link mode of operation using at least one of: a basic multi-link element, a reduced neighbor report, an additional element in a beacon frame, another management (i.e. action) frame, a trigger frame, or a control frame.

14. The first WLAN device of claim 13:
wherein the announces includes a link identifier (ID) that identifies which of the WLAN devices is using which link as the primary link, and which link as the non-primary link.

15. The first WLAN device of claim 1:
wherein the primary link and a non-primary link are in a same power save mode at a same time.

16. The first WLAN device of claim 1:
wherein the primary link and a non-primary link are in a different power save mode at a same time.

17. The first WLAN device of claim 1:
wherein the primary link and a non-primary link are in an awake state in a power save mode at a same time.

18. The first WLAN device of claim 1:
wherein at least one of the first and second WLAN devices is a multi-link single-radio (MLSR) device.

19. The first WLAN device of claim 1:
wherein at least one of the first and second WLAN devices is a multi-link multi-radio (MLMR) device.

20. The first WLAN device of claim 1:
wherein at least one of the first and second WLAN devices is a STR (Simultaneous Transmit and Receive) MLMR (Multilink Multi-Radio) MLD device.

21. Method of enabling a first WLAN (wireless local area network) device to be operated, comprising:
establishing a multi-link association with a second WLAN device;
wherein the multi-link association includes a primary link and a non-primary link;
detecting that the primary-link is busy; and
performing frame exchanges on the non-primary link if the primary-link is busy.
